(19) United States
(12) Patent Application Publication
(10) Pub. No.: US 2015/0360529 A1
(43) Pub. Date: Dec. 17, 2015

(54) MOTOR VEHICLE

(71) Applicant: AUDI AG, Ingolstadt (DE)

(72) Inventors: Christoph MÜLLER, Oberthulba (DE); KARL-HEINZ SIEDERSBERGER, Ingolstadt (DE)

(73) Assignee: Audi AG, Ingolstadt (DE)

(21) Appl. No.: 14/763,435

(22) PCT Filed: Dec. 19, 2013
(86) PCT No.: PCT/EP2013/003876

§ 371 Date: Jul. 24, 2015

(30) Foreign Application Priority Data
Jan. 26, 2013 (DE) 10 2013 001 305.4

(51) Int. Cl. B60G 17/016; B60G 17/0195

(52) U.S. Cl. CPC B60G 17/016; B60G 17/0195

(57) ABSTRACT

A motor vehicle includes a plurality of actuators for carrying out movements of the chassis, wherein the motor vehicle includes a control device for determining orientation information describing an orientation of the chassis to be assumed with regard to at least one target setting, wherein the control device is designed to control the actuators on the basis of the orientation information in such a way that the actuators carry out in a combined manner pitching, rolling and vertical movements of the chassis in order to orient the chassis corresponding to the orientation described by the orientation information.

The invention relates to a motor vehicle including multiple actuators for performing movements of the chassis.

It is known to introduce movements, i.e., pitching-, rolling- or vertical movements into the chassis of a motor vehicle via so-called active chasses. The purpose of a corresponding movement of the chassis can in particular be to compensate unevenness of the road surface, for which usually vertical movements of the chassis are performed, or to improve the dynamic properties of the motor vehicle for example when driving through curves, for which usually rolling movements of the chassis are performed to cause the motor vehicle to “lean into the curve”.

For performing movements of the chassis the motor vehicle includes a number of actuators. Usually the chassis is caused to perform pitching-, or rolling movements relative to the longitudinal axis of the motor vehicle or vertical movements relative to the vertical axis of the motor vehicle.

Thus such movements of the motor vehicle or changes of the orientation of the chassis, which are based on the control of corresponding actuators for performing pitching-, rolling- and vertical movements of the chassis, are always limited to only one degree of freedom, i.e., the chassis either performs pitching- or rolling- or vertical movements.

The invention is based on the object to set forth a motor vehicle whose chassis can be moved in degrees of freedom at the same time.

The object is solved according to the Invention by a motor vehicle of the aforementioned type, which is characterized in that it includes a control device for determining orientation information, which describes an orientation of the chassis to be performed with regard to at least one target setting, wherein the control device is configured to control the actuators based on the orientation information so that the actuators in combination perform pitching-, rolling- and vertical movements of the chassis in order to orient the chassis according to the orientation described by the orientation information.

The principle according to the invention enables a combined, i.e., simultaneous performance of pitching-, rolling- and vertical movements of the chassis. Thus the chassis can be moved in more than one, in particular three, independent degrees of freedom. Pitching movements are defined as movements of the chassis, in particular rotational movements, about a transverse axis of the motor vehicle, rolling movements are defined as movements of the chassis, in particular rotational movements, about a longitudinal axis of the motor vehicle, vertical movements are defined as movements of the chassis along a vertical axis of the motor vehicle. The longitudinal, transverse and vertical axes of the motor vehicle are perpendicular to each other and form an orthogonal coordinate system whose origin is for example situated in the center of gravity of the motor vehicle.

The actuators of the motor vehicle are controlled via a control device, which communicates with the actuators, or with control devices assigned to the actuators, on the basis of an item of orientation information, which was determined beforehand with regard to a defined target setting of the motor vehicle. In the control device certain algorithms, which may for example be referred to as quality function, can be stored for determining the orientation information and enable determining the orientation information.

The orientation information describes an orientation of the chassis to be performed with regard to at least one target setting. The orientation information thus contains all instructions for controlling the actuators of the motor vehicle, in order to control these actuators so that they perform in combined pitching-, rolling, and vertical movements, in order to orient the chassis in accordance with the orientation described by the orientation information.

Based on a given actual orientation of the chassis, the proportions of the pitching-, rolling, and vertical movements to be performed, that are described by the orientation information are usually different, in order to orient the chassis in accordance with the predetermined or predeterminable target setting, which corresponds to a target orientation of the chassis.

Generally it is not strictly required to always control all actuators for preforming pitching- rolling and vertical movements of the chassis, to orient the chassis in accordance with a defined target setting, rather it may be sufficient to only control individual actuators to perform the combined pitching- rolling and vertical movements of the chassis to be performed.

The target setting may be a setting of the chassis that influences the driving characteristics of the motor vehicle, and according to which the chassis is for example always to be oriented so that a greatest possible comfort for the vehicle occupants is ensured under given driving situations. The target setting can be referred to as target orientation of the chassis. The orientation of the chassis described by the target setting, in particular results in the fact that no or at least decreased longitudinal and transverse forces act on the vehicle occupants under the actual driving conditions of the motor vehicle. According to the invention the chassis is caused to under defined movements and/or tilts by actively controlling corresponding actuators, in order to actively cause a targeted shift of the rotation axis or axes occurring due to the drive, i.e., pitching- rolling and vertical movement axes, so that the drive-related longitudinal and/or transverse forces acting on the vehicle occupants are compensated.

For example based on a given driving situation of the motor vehicle and a resulting actual orientation of the chassis, a change of the orientation of the chassis may be indicated, in order to increase the comfort of the vehicle occupants by reducing or compensating the longitudinal and transverse forces acting on the vehicle occupants. Which new orientation of the chassis leads to an increase of the driving comfort under the given conditions is described by the determined orientation information. Taking the target setting into account, via which a corresponding increase of the comfort based on a reduction or compensation of the longitudinal and transverse forces acting on the vehicle occupants is to be expected, the orientation information describes a change of the orientation of the chassis to be performed based on the actual orientation of the chassis, in order to realize a target orientation of the chassis which corresponds to the target setting.

The orientation of the chassis is thus changed based on the orientation information, i.e., based on the orientation information the control device determines corresponding control commands to the actuators for performing pitching- rolling and vertical movements of the chassis, in order to orient the chassis in correspondence with the orientation described by the orientation information. The actuators are thus controlled on the basis of the orientation information so that the chassis is moved or oriented from the actual orientation into a target orientation. By controlling the actuators a virtual shifting of the axes, i.e., for example a pitching- rolling and vertical axis, about which the vehicle would rotate due to the actual driving situation, can thus be realized. The chassis consequently rotates about the shifted rotation axis or axes, wherein drive-related longitudinal forces and/or transverse forces acting on the vehicle occupants are neutralized.

The orientation information In particular describes a trajectory about which the chassis has to be moved in order to assume the orientation to be performed, and control commands to the actuators regarding pitching- rolling and vertical movements about the trajectory, which are required to move the chassis about the trajectory into the orientation to be performed. The trajectory, which can also be referred to as target axis, projects hereby an in particular three-dimensional spatial axis or spatial curve, which for example extends through the chassis, however, may generally also be located outside the chassis.

The trajectory then projects corresponding axes for the individual movement components of the chassis to be performed for the combined pitching-rolling and vertical movements of the chassis to be performed. For this the orientation information contains corresponding control commands to the actuators for performing pitching- rolling and vertical movements of the chassis, which are required to move the chassis about the trajectory into the orientation to be performed, which corresponds to the target setting of the chassis. As mentioned above it is not strictly required to always control all actuators for performing pitching- rolling and vertical movements of the chassis, to orient the chassis in accordance with a defined target setting, rather the control of only individual actuators may be sufficient for the combined performance of pitching- rolling and vertical movements of the chassis.

Advantageously the control device is configured to take an actual orientation of the chassis into account for the determination of the orientation information. The actual orientation of the chassis can thus serve as a boundary condition to be taken into account for determining the orientation information. When determining the orientation information it is therefore possible, as mentioned, to take an actual orientation of the chassis into account. The actual orientation of the chassis can for example describe by what value (for example percentage or angular) the chassis has changed relative to a reference value, which for example describes the orientation of the chassis when the motor vehicle stands on a horizontal or even ground. Thus for example in case of an uphill drive it can be expected that the actual orientation of the chassis compared to the reference value contains at least a rearward pitching movement because the motor vehicle usually is lowered in the rear region when driving uphill. With regard to a target setting of the chassis, which increases the driving comfort, it is for example possible in the case of uphill drives to control the actuators for performing pitching- rolling and vertical movements of the chassis based on the orientation information so that these movements compensate the actual orientation of the chassis during the uphill drive, i.e., they cause a frontward pitching movement of the chassis. The opposite applies for a downhill drive.

Further, the control device can be configured to take further operating parameters of the motor vehicle, such as actual acceleration of the motor vehicle, in particular in longitudinal transverse and vertical direction, steering wheel angle or yaw angle into account for determining the orientation information. Also the mentioned operating parameters of the motor vehicle can be referred to as boundary conditions. In this way it is for example possible to take steering operations performed during a drive through a curve in the determination of the orientation information into account. The trajectory described by the orientation information is determined in this situation for example by taking the steering movement, and as the case may be further operating parameters of the motor vehicle such as transverse acceleration and yaw angle associated therewith, into account. Corresponding operating parameters of the motor vehicle can be detected via sensors, which communicate with the control device. The operating parameters of the motor vehicle taken into account in the determination of the orientation information may be weighted against each other so that certain operating parameters have a greater influence during the determination of the orientation information than others.

When the motor vehicle is moved toward an obstacle situated ahead of the motor vehicle and is correspondingly decelerated, actual given deceleration values in longitudinal direction of the motor vehicle, i.e., negative acceleration values in longitudinal direction of the motor vehicle, can be taken into account in the determination of the orientation information.

The actuators are for exampled configured for controlling devices for height adjustment of the chassis, at least one drive aggregate, at least one braking device, at least one steering device, at least one driver assistance system for longitudinal and/or transverse guidance. Devices for height adjustment of chasses are known and are for example referred to as “active chassis”. Via corresponding devices for height adjustment of the chassis it is for example possible to adjust the spring mount of a spring damper element, which forms a part of a wheel suspension and is also referred to as shock absorber. Via a targeted adjustment for example of the spring mount of one or multiple spring damper elements, pitching- rolling- or vertical movements can be introduced into the chassis in a targeted manner depending on at which spring damper element a corresponding spring mount is adjusted.

By controlling the drive aggregate in a targeted manner, for example by acceleration or deceleration processes, a virtual shift of the axes, i.e., in particular a pitching axis about which the motor vehicle would rotate as a result of the actual driving situation, can be achieved. For example, acceleration of the vehicle usually results in a pitching movement of the chassis, wherein the rear part of the motor vehicle is lowered. Vice versa, deceleration of the motor vehicle due to actuating braking devices of the motor can lead to a lowering of the front part of the motor vehicle and with this to opposite pitching movements of the chassis.

All acceleration or deceleration movements of the motor vehicle performed on the basis of the orientation information are preferably carried out so as to be not or only slightly perceptible for the vehicle occupants and other road users such as following motor vehicles.

The virtual shifting of a rolling axis of the chassis described above can for example be accomplished by targeted, autonomous steering interventions, i.e., steering operations that are independent of the driver, for example as known for driver assistance systems that support an autonomous transverse guidance of a motor vehicle.

The invention also relates to a method for performing combined pitching-, rolling- and vertical movements of a chassis of a motor vehicle. According to the method, an item of orientation information is determined, which describes an orientation of the vehicle to be performed with regard to at least one target setting. Based on the orientation information, actuators for performing pitching-, rolling- and vertical movements of the chassis are controlled in order to orient the chassis in accordance with the orientation described by the orientation information. As a result of the control of the actuators based on the orientation information, a virtual shift of the rotation axes that occur due to the actual driving situation of the motor vehicle can be performed. Thus a braking process and/or steering intervention caused by actuators in a targeted manner allows achieving a virtual shift of the pitching-, rolling- and vertical axes of the chassis of the motor vehicle in order to compensate or at least reduce the drive-related longitudinal and/or transverse forces acting on the vehicle occupants. Hereby it is conceivable to reduce the forces acting in longitudinal and/or transverse direction on the vehicle occupants or example only to a certain degree. The reduction of the longitudinal and transverse forces acting on the vehicle occupants hereby does not have to be proportionally equal, so that for example the longitudinal forces acting on the vehicle occupants are reduced to a greater degree than the transverse forces acting on the vehicle occupants and vice versa. Depending on the circumstances, an increase of the drive related longitudinal and/or transverse forces acting on the vehicle occupants is also conceivable.

The method according to the invention can be performed independently or parallel to further driver assistance systems, which may influence individual pitching-, rolling- and vertical movements of the chassis, such as a driver assistance system for compensating unevenesses of the road surface.

Generally all explanations set forth in connection with the motor vehicle according to the invention also apply analogously for the method according to the invention.

Thus it is useful that the determined orientation information describes a trajectory, about which the chassis has to be moved in order to assume the orientation to be performed, and control demands to the actuators relating to pitching-, rolling- and vertical movements, which are required to move the chassis about the axis into the orientation to be performed.

Advantageously also a number of input parameters, which may also be referred to as boundary conditions, are taken into account for the determination of the orientation information. This includes for example an actual orientation of the chassis. It is also conceivable in addition or as an alternative to take actual acceleration values of the motor vehicle, in particular in longitudinal, transverse or vertical direction, steering angle and yaw angle into account for the determination of the orientation information.

Within the framework of the method according to the invention, the orientation information is used for controlling corresponding actuators for performing pitching-, rolling- and vertical movements of the chassis, i.e., for controlling actuators that are capable of causing the chassis to undergo pitching-, rolling- and vertical movements in order to cause a virtual shift of the rotation axes occurring as a result of the actual driving situation, i.e., in particular pitching-, rolling- and vertical axes, with the goal to compensate or at least reduce the drive-related longitudinal and/or transverse forces acting on the vehicle occupants. Actuators that may be used include for example actuators for height adjustment of the chassis or devices for height adjustment of the chassis, actuators for controlling at least one drive aggregate, actuators for controlling at least one braking device, actuators for controlling at least one steering device and actuators for controlling at least one driver assistance system for longitudinal and/or transverse guidance of the motor vehicle.

Further advantages, features and details of the invention will become apparent form the exemplary embodiments described below and from the drawings. It is shown in

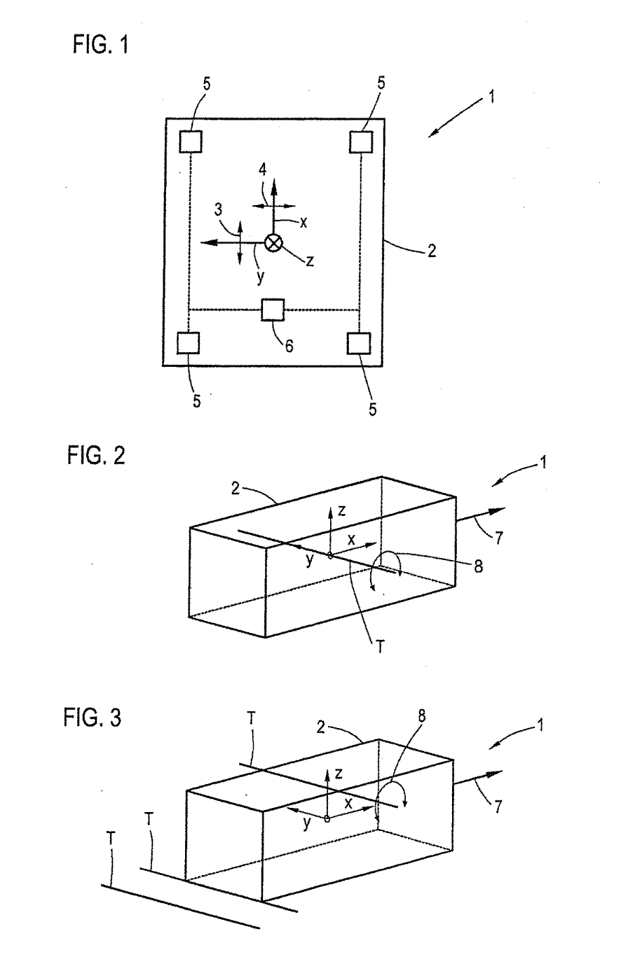

FIG. 1 a schematic representation of a top view onto a motor vehicle according to an exemplary embodiment of the invention; and

FIGS. 2-5 respectively, schematic representations of a motor vehicle according to an exemplary embedment of the invention.

FIG. 1 shows a schematic representation of a top view onto a motor vehicle 1 according to an exemplary embodiment of the invention. FIG. 1 serves in particular to define via which degrees of freedom the chassis 2 of the motor vehicle 1 can be moved by performing combined pitching-, rolling- and vertical movements.

For this an orthogonal coordinate system is drawn into FIG. 1 whose x-axis extends in the direction of the longitudinal axis of the motor vehicle 1, whose y-axis extends in the direction of the transverse axis of the motor vehicle 1 and whose z-axis extends in the direction of the drawing plane of the motor vehicle 1. The center of the coordinate system in in the center of gravity of the motor vehicle 1. Pitching movements of the motor vehicle 1 are rotations of the chassis 2 about the y-axis (see double arrow 3), rolling movements of the motor vehicle 1 are rotations of the chassis 2 about the x-axis (see double arrow 4) and vertical movements of the chassis 2 are translational movements of the chassis 2 along the z-axis.

For preforming combined pitching-, rolling- and vertical movements of the chassis 2, the motor vehicle 1 has appropriate actuators 5. Corresponding actuators 5 for preforming pitching-, rolling- and vertical movements are for example actuators or devices for transverse and/or height adjustment of the chassis 2 as part of an “active chassis” with which it is possible to change for example the spring mount of a spring damper element which forms a part of the wheel suspension and is referred to as shock absorber. Via a targeted adjustment for example of the spring mount of one or multiple spring damper elements, pitching-, rolling- and vertical movements can be introduced into the chassis 2 in a targeted manner depending on at which spring damper element the corresponding spring mount adjustment occurs.

Corresponding actuators 5 for causing pitching movements of the chassis are for example actuators which are configured for controlling a drive aggregate of the motor vehicle 1 and/or braking devices of the motor vehicle 1. Controlling the drive aggregate in a targeted manner enables for example a targeted (virtual) shift of a pitching axis resulting from the actual driving situation, in x-direction and/or z-direction, about which pitching axis the chassis 2 rotates due to the drive. Vice versa, a targeted control of the braking device of the motor vehicle during driving of the motor vehicle results in a negative acceleration (deceleration) of the motor vehicle 1, with which also a targeted (virtual) shift of a pitching axis resulting from the actual driving situation, about which pitching axis the chassis 2 rotates due to the drive, in x-direction and/or z-direction, can be achieved. This requires a combined control of corresponding actuators 5 as part of a so-called “active chassis” i.e., actuators 5 that cause a height adjustment in the region of individual wheel suspensions of the motor vehicle 1. The (virtual) shift of the pitching axis given by the actual driving situation thus occurs in combination with pitching-, rolling- and vertical movements of the “active chassis”.

By controlling multiple drive aggregates in a targeted manner, which are distributed over the motor vehicle and which for example each are provided respectively for driving a defined vehicle wheel, and/or braking devices, which are for example provided for braking a defined vehicle wheel, a (virtual) shift of pitching- and rolling axes can be achieved via the actuators for controlling the drive aggregates or the braking devices of the motor vehicle.

Further actuators 5 for performing pitching-, rolling- and vertical movements of the chassis 2, and with this for realizing the aforementioned (virtual) shift of corresponding rotation axes, about which the chassis 2 rotates as a result of the drive, are actuators for controlling a steering device, which interacts with at least one steerable axle of the motor vehicle 1 or actuators for controlling driver assistance systems for longitudinal and/or transverse guidance of the motor vehicle 1.

The actuators 5, which generally can be controlled individually, group-wise or simultaneously, are controlled via a control device 6, which communicates with the actuators via appropriate communication connections, such as a central vehicle bus (CAN-bus).

The control of the actuators 5 via the control device 6 occurs on the basis of an item of orientation information determined by the control device 6. The orientation information describes an orientation of the chassis 2 to be performed starting from its actual orientation with regard to a target orientation of the chassis 2 which corresponds to a target setting or target configuration of the chassis 2. The orientation information thus describes how and which actuators 5 have to be controlled in order to bring the chassis 2 from its actual orientation into the target orientation defined by the target setting via the (virtual) shifting of corresponding rotation axes such as nick- and/or rolling axes, based on the control of corresponding actuators 5. The target setting, which is taken into account in the determination of the orientation information, describes for example an orientation of the chassis 2 that increases comfort of the vehicle occupants under the actual operating conditions of the motor vehicle 1.

The Increase of the comfort for the vehicle occupants is achieved in that the longitudinal and/or transverse forces acting on the vehicle occupants during the drive are compensated or at least reduced. Thus the actuators 5 are controlled via the control device 6 based on the orientation information so that the actuators 5 compensate or at least reduce the longitudinal and/or transverse forces acting on the vehicle occupants during the drive. The reduction of the longitudinal and/or transverse forces acting on the vehicle occupants does hereby not have to be proportional so that for example the longitudinal forces acting on the vehicle occupants are reduced to a greater degree than the transverse forces acting on the vehicle occupants or vice versa.

The orientation information describes on one hand a trajectory T or an axis about which the chassis 2 has to be moved in order to assume the orientation to be performed in order to reach the target setting. On the other hand the orientation information describes control commands to the actuators regarding the combined pitching-, rolling- and vertical movements about the trajectory T, which are required to actively move the chassis 2 about the trajectory T into the orientation to be performed, i.e., from its actual orientation into the target orientation.

Beside the mentioned actual orientation of the chassis 2, the control device 6 also takes actual operating parameters of the motor vehicle 1 into account for the determination of the orientation information, such as actual acceleration values of the motor vehicle 1 detected by appropriate sensors, in particular in longitudinal, transverse or vertical direction, actual steering angle, actual wheel angle of one of multiple vehicle wheels and actual yaw angle of the motor vehicle 1.

In the following the principle according to the invention is described by way of an exemplary driving situation in which the motor vehicle 1 moves along a curve of a road toward a stop sign, a traffic light or other obstacle, which requires braking of the motor vehicle (see also FIG. 2-5 with associated description).

In response to recognizing the stop sign for example the driver or a longitudinally guiding system of the motor vehicle brakes the motor vehicle 1. The pitch movement induced by the braking or deceleration of the motor vehicle 1 is to be overcompensated in this case, as is also the case for the slanted orientation of the chassis 2 due to the curve drive. The orientation determination of the chassis 2 determined via the control device 6 describes thus a trajectory T about which the chassis 2 has to be moved in order to achieve the target orientation of the chassis 2 described by the orientation information. The target setting can correspond to a slanted position of the chassis 2 relative to a horizontal plane, in order to overcompensate the nick- and rolling movement of the chassis 2 caused by the braking or the curve drive and thereby compensate drive-related longitudinal forces acting on the vehicle occupants and in this way increase the comfort of the vehicle occupants.

Based on the orientation information, the control device 6 controls appropriate actuators 5, i.e., in the present case for example the drive aggregate and corresponding height-adjustable components of shock absorbers, which are assigned to respective vehicle wheels, in order to achieve a virtual shift of the pitch axis of the chassis 2 resulting from the drive. Thus the motor vehicle 1 can be slightly accelerated via a control of the drive aggregate to achieve a shift of the pitch axis, wherein overall it is of course still ensured that the motor vehicle 1 brakes with regard to the obstacle ahead.

Likewise, a height adjustment of the chassis 2 occurs via a control of the devices for height adjustment of the height adjustable components of the shock absorber, for example on the driver side of the motor vehicle 1, in order to overcompensate the rolling movements with the goal to compensate the drive-related transverse forces acting on the vehicle occupants.

For this a simultaneous control of other devices for height-compensation of the height-adjustable components of further shock absorbers occurs in order to additionally compensate vertical movements into the chassis 2, which serve for compensating or smoothening all movements induced into the chassis 2 and thereby make these movements almost imperceptible for the vehicle occupants. As a result of the simultaneously performed vertical movements of the chassis 2 it is in particular also possible to compensate possible unevenesses of the road surface.

FIGS. 2-5 respectively show schematic representations of a motor vehicle 1 according to exemplary embodiments of the invention. FIGS. 2-5 illustrate which trajectories T respectively described by the orientation information can be present depending on different operating conditions or driving situations of the motor vehicle 1. Based on FIGS. 2-4, two exemplary driving situations of the motor vehicle 1, which is here shown in a perspective rear view, are first illustrated. The motor vehicle 1 moves in the direction of the arrow 7. The chassis 2 of the motor vehicle 1 is regarded as rigid body.

According to FIG. 2 the motor vehicle 1 moves according to arrow 7 toward an obstacle, such as a red traffic light. The driver or a driver assistance system for longitudinal guidance of the motor vehicle 1 brakes the motor vehicle 1. As a result of the deceleration the also schematically shown chassis 2 of the motor vehicle 1 is lowered, i.e., in the region of the front axle, and is raised in the rear, i.e., in the region of the rear axle. The change of the orientation of the chassis 2 relative to is neutral position corresponds to a rotation of the chassis 2 about the y-axis illustrated by the double arrow 8, in the direction of the arrow 7, and with this to a frontward pitch movement of the chassis 2.

In order to realize a compensation of the described pitch movement of the chassis 2 the orientation information describes a trajectory T, about which the chassis 2 has to be rotated by controlling corresponding actuators 5, in order to compensate the longitudinal forces acting on the vehicle occupants due to the deceleration. Correspondingly a rotation of the chassis 2 also about the y-axis opposite to the direction of the double arrow 8 in the opposite direction of the arrow 7 has to be effected. A pitch movement, which is opposite to the pitch movement caused by the deceleration has to be induced into the chassis 2. This can for example be accomplished by an appropriate upward adjustment of the spring mount of the shock absorber of the front axle, so that the motor vehicle 1 is raised in the region of the front axle. The rotation of the chassis 2 described by the orientation information corresponds in its value not the rotation of the chassis 2 caused by the deceleration but exceeds it. Hereby the trajectory T descried by the orientation information is situated exactly in the y-axis or coincides with the y-axis. The vertical position of the y-axis is here for example the waist height of a vehicle occupant.

Depending on the respective target setting, which as mentioned relates to an increase of the vehicle occupant comfort based on the compensation of longitudinal and/or transverse forces acting on the vehicle occupants, the trajectory T can also have a different vertical position above the y-axis, i.e., it can be shifted in the direction of the z-axis relative to the origin of the coordinate system which lies in the center of gravity of the motor vehicle 1, and thus may for example be located in the region of the head of a vehicle occupant (see FIG. 3). In order to realize this by means of the actuators 5, for example a control of the drive aggregate is conceivable which carries out a temporary short acceleration of the motor vehicle 1, due to which the chassis 2 is lifted in the region of the front axle.

It is noted in this context that the trajectory T descried by the orientation information does not strictly have to be located within the chassis 2. The trajectory T can also be located in peripheral regions of the motor vehicle 1, i.e., within the front or rear bumper or even completely outside, i.e., positioned behind the motor vehicle 1 by a defined distance (see FIG. 3).

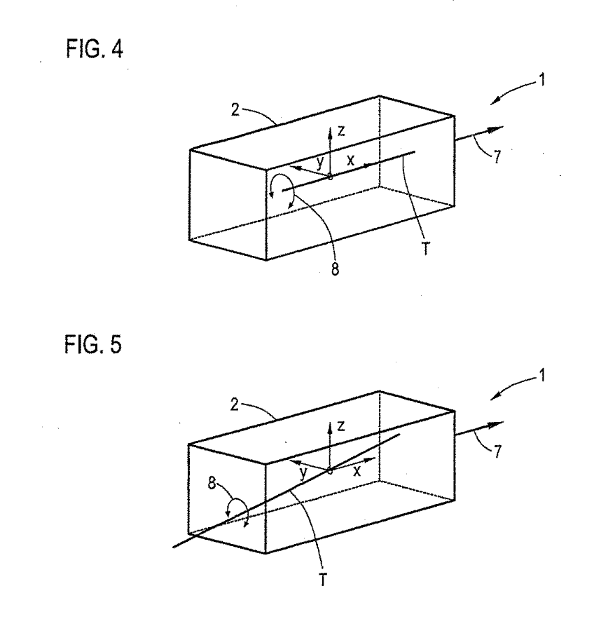

According to FIG. 4 the motor vehicle 1 moves in the driving direction indicated by the arrow 7 through a left curve. Due to the centripetal forces acting on the moving motor vehicle 1 the chassis 2, which is regarded as rigid body, tilts outwardly, which corresponds to a rotation of the chassis 2 about the x-axis and thus corresponds to a rolling movement. Correspondingly a trajectory T, which is located in the x-axis, is determined on the basis of the orientation information and the rotation axis of the chassis 2 resulting from the drive is shifted via a control of corresponding actuators 5 so that the rotation axis coincides with the trajectory T. Correspondingly a rotation of the chassis 2 towards the left (see double arrow 8) is caused so that the outward tilt of the motor vehicle 1 caused by the centripetal forces is overcompensated by a rotation of the chassis 2 about the x-axis toward the left, i.e., the rolling movement of the chassis 2 caused by the shifting of the axis is greater than the original rolling movement resulting from the drive. For this, i.e., in order to realize a corresponding shift of the rolling axis, for example actuators 5 situated on the co-driver's side for height adjustment of the chassis 2, can be controlled, i.e., in particular a height adjustment of the spring mount of the shock absorber arranged on the co-drivers side.

The reduction of the longitudinal forces and transverse forces acting on the vehicle occupants that can be accomplished hereby does not have to be proportional, so that for example the longitudinal forces acting on the vehicle occupants are reduced to a greater degree than the transverse forces acting on the vehicle occupants.

FIG. 5 shows a representation, which illustrates the principle of the invention particularly well. The motor vehicle 1 is in a driving situation, which is a combination of the driving situations shown in FIGS. 2-4. The motor vehicle 1 thus moves in a left curve toward an obstacle such as a red traffic light. The chassis 2 thus undergoes an outward tilting about the x-axis, i.e., a rolling movement, and due to the deceleration in response to the obstacle ahead of the motor vehicle 1 a frontward tilting about the y-axis, i.e. a pitching movement.

The resulting trajectory T described by the orientation information is correspondingly formed by an addition or combination of the trajectories T shown in FIGS. 2-4 and extends obliquely through the chassis 2.

The trajectory T includes consequently a portion in order to overcompensate the rolling movement of the chassis 2 caused by the curve drive, and a portion to overcompensate the pitching movement caused by the deceleration.

In other words a targeted (virtual) shifting of the rotation axes resulting from the drive is realized by controlling corresponding actuators 5, so that the chassis 2 rotates about the trajectory T which leads to an overcompensation of the rolling- and pitching movement of the chassis 2 caused by the curve drive and deceleration. On the basis of the orientation information control commands to appropriate actuators 5 are determined via which thus for example on the side of the co-driver a height adjustment of the spring mount of the shock absorber occurs. In order to overcompensate the rolling movement of the chassis 2 caused by the curve drive via a corresponding active shift of the rotation axes, i.e., to exceed the value of the rolling movement, a targeted steering intervention in correspondingly opposite direction can also be realized based on the orientation information via the control of actuators that interact with the steering wheel. Of course the steering intervention is such that the motor vehicle 1 does not drive off the road and stays within its lane. This can for example be ensured via likewise active appropriate driver assistance systems.

At the same time the drive aggregate can be actively controlled, in order to overcompensate the mentioned shifting of the rotation axes or rotation movements of eh chassis 2 that are present due to the drive, which additionally or alternatively can also be caused by an adjustment of the spring mount of shock absorbers assigned to the front axle, which leads to raising of the chassis 2 in the region of the front axle.

Thus based on the orientation information determined by the control device 6 and the targeted control of actuators 5 of the motor vehicle based thereon, the motor vehicle 1 or the chassis 2 undergoes targeted introduced combined pitching-, rolling- and vertical movements, i.e., rotation movements about the trajectory T, which is based on a virtual shifting of the actual rotation axis of the chassis 2 occurring as a result of the drive, in correspondence with the orientation information in x- and y-axis and also z-axis. The chassis 2 can thus be moved in a great number of degrees of freedom, in order to overcompensate the movements resulting from the actual driving situation and introduced into the chassis 2, with regard to the target setting, which in particular describes an orientation of the chassis 2 that relates to an increase of the vehicle occupant comfort by a targeted compensation of the longitudinal and transverse forces acting on the vehicle occupants under the actual operating conditions of the motor vehicle 1.

1.-14. (canceled)

15. A motor vehicle, comprising:
multiple actuators for performing movements of the chassis; and
a control device for determining an orientation information, which describes a target orientation of the chassis to be assumed with regard to at least one target setting, said control device being configured to control the actuators based on the orientation information so that the actuators perform combined pitching-, rolling- and vertical movements of the chassis, in order to orient the chassis corresponding to the target orientation described by the orientation information.

16. The motor vehicle of claim 15, wherein the orientation information describes a trajectory about which the chassis is to be moved in order to assume the target orientation, and control commands for controlling the actuators, said control commands relating to the trajectory and causing the actuators to move the chassis about the trajectory into the target orientation.

17. The motor vehicle of claim 15, wherein the control device is configured to take an actual orientation of the chassis into account for determining the orientation information.

18. The motor vehicle of claim 15, wherein the control device is configured to take at least one of actual acceleration values of the motor vehicle, in particular in longitudinal, transverse or vertical direction, a steering angle and a yaw angle, into account for determining of the orientation information.

19. The motor vehicle of claim 15, wherein the actuators are configured for controlling a member selected from the group of devices for transverse adjustment and height adjustment of the chassis, at least one drive aggregate, at least one braking device, at least one steering device, and at least one driver assistance system for longitudinal and/or transverse guidance.

20. The motor vehicle of claim 15, wherein the target setting describes an orientation of the chassis which increases a comfort of an occupant of the motor vehicle under actual operating conditions of the motor vehicle.

21. The motor vehicle according to claim 20, wherein the target setting describes a compensation or at least a reduction of drive-related longitudinal and/or transverse forces acting on the occupant of the vehicle.

22. A method for performing combined movements of a chassis of a motor vehicle, comprising:
determining an item of orientation information which describes a target orientation of the chassis to be assumed with regard to at least one target setting,
controlling actuators as a function of the orientation information so that the actuators perform combined pitching-, rolling and vertical movements of the chassis, thereby orienting the chassis to assume the target orientation described by the orientation information.

23. The method of claim 22, wherein the orientation information describes a trajectory about which the chassis has to be moved to assume the target orientation, and control commands for controlling the actuators, said control commands relating to pitching-, rolling and vertical movements about the trajectory and causing the actuators to move the chassis about the trajectory into the target orientation.

24. The method of claim 22, further comprising taking an actual orientation of the chassis into account for determining the orientation information.

25. The method of claim 22, further comprising taking a member selected from the group consisting of an actual acceleration value of the motor vehicle, in particular in longitudinal transverse or vertical direction, a steering angle and a yaw angle, into account for determining the orientation information.

26. The method of the claim 22, wherein the actuators are configured for controlling at least one member selected from the group consisting of devices for transverse and height adjustment of the chassis, at least one drive aggregate, at least one braking device, at least one steering device, and at least one driver assistance system for longitudinal and/or transverse guidance of the motor vehicle.

27. The method of claim 22, wherein the target setting describes an orientation of the chassis which increases comfort of occupants of the vehicle under actual operating conditions of the motor vehicle during a drive of the motor vehicle.

28. The method of claim 27, wherein the target setting describes a compensation or at least a reduction of longitudinal and/or transverse forces acting on the occupants of the vehicle as a result of the drive.
